(19) United States
(12) Patent Application Publication
(10) Pub. No.: US 2016/0011601 A1
(43) Pub. Date: Jan. 14, 2016

(54) HYDRAULIC CONTROL SYSTEM

(71) Applicant: TOYOTA JIDOSHA KABUSHIKI KAISHA, Toyota-shi, Aichi (JP)

(72) Inventors: Takafumi INAGAKI, Toyota-shi (JP); Yuji HATTORI, Toyota-shi (JP); Kenta KIMURA, Toyota-shi (JP); Yu NAGASATO, Toyota-shi (JP)

(73) Assignee: Toyota Jidosha Kabushiki Kaisha, Toyota-shi, Aichi (JP)

(21) Appl. No.: 14/653,564

(22) PCT Filed: Dec. 21, 2012
(86) PCT No.: PCT/JP2012/083219

§ 371 Date: Jun. 18, 2015

(51) Int. Cl. G05D 7/06; G05B 11/42; G05D 27/02; F16K 31/06; G05D 16/20

(52) U.S. Cl. CPC G05D 7/0635; F16K 31/0644; G05D 16/2013; G05D 27/02; G05B 11/42

(57) ABSTRACT

The present invention relates to a hydraulic control system having a feeding passage to a control object, a draining passage from the control object, and a control valve disposed on one of the passages is provided. The valve is adapted to deliver or drain the fluid to/from the control object in accordance with an applied current calculated based on a difference between a target pressure and an actual pressure of the control object. The hydraulic control system is configured to calculate a desired fluid volume to adjust the actual pressure to the target pressure based on said pressure difference, and to calculate a current value to achieve the desired fluid volume based on a relation between a current value applied to the control valve and an outflow rate of the fluid.

### TECHNICAL FIELD

The present invention relates to a hydraulic control system for controlling hydraulic pressure applied to a predetermined actuator.

### BACKGROUND ART

As well known in the art, a thrust force, a torque or a position of an actuator of hydraulic systems in various fields can be controlled arbitrarily by changing pressure and amount of oil applied to the actuator to transmit a power and a signal. For example, Japanese Patent Laid-Opens Nos. 2011-163508 and 2011-52796 describe hydraulic control devices for an automatic transmission of automobiles such as a belt-driven continuously variable transmission. The continuously variable transmission is comprised of a drive pulley, a driven pulley and a V-shaped drive belt running in the grooves of those pulleys, and a speed ratio of the continuously variable transmission can be varied continuously by changing groove widths of those pulleys to change running radii of the belt applied thereon. That is, in the continuously variable transmission, torque is transmitted frictionally between each pulley and the belt. Specifically, a speed ratio of the continuously variable transmission is controlled by adjusting an amount or a pressure of the oil delivered to a hydraulic chamber (i.e., an actuator) of one of the pulley, and a belt clamping pressure governing a torque transmitting capacity is controlled by adjusting a pressure applied to the hydraulic chamber of the other pulley.

According to the hydraulic control devices taught by Japanese Patent Laid-Opens Nos. 2011-163508 and 2011-52796, poppet valves are used to selectively open and close a feeding passage and a discharging passage connected to the chambers of the pulleys to control high pressure applied to the pulleys, instead of a conventional regulator valve. The conventional regulator valve has a feedback port, and a feedback pressure and a regulating pressure are balanced across a spool. In the regulator valve of this kind, a drain port is opened to drain the oil when the feedback pressure is high, and the drain port is closed to provide a communication between an inlet port and an outlet port when the feedback pressure is low. That is, an output pressure of the regulator valve is increased by raising the regulating pressure counteracting to the feedback pressure. However, a large amount of the oil delivered from an oil pump may be drained from the drain port as a result of regulating oil pressure by thus opening and closing the drain port. Especially, in the regulator valve having the spool, an oil leakage would be caused inevitably to ensure a smooth movement of the spool. Thus, according to the conventional regulator valve having the feedback port, a power loss is caused due to such oil leakage especially under high pressure.

For this reason, according to the teachings of those prior art documents, a poppet valve adapted to close an oil passage by pushing a valve element onto a seat and to open the passage by isolating the valve element away from the seat is used to control the pressure applied to each pulley. Therefore, an internal pressure of the chamber of each pulley can be controlled by detecting the internal pressure by a sensor and controlling a feed control valve or a drain valve in a manner to adjust the detected pressure to a target pressure. In addition, the internal pressure of the chamber can be maintained by closing the feed valve and the drain valve so that an occurrence of oil leak can be prevented to improve energy efficiency.

According to the teachings of Japanese Patent Laid-Open No. 2011-163508, specifically, a balance piston valve in which a high input pressure and a low output pressure counteract to each other across a piston integrated with a valve element. That is, the balance piston valve is closed by a pressure difference between the input and output pressures, and opened by connecting one of the chambers defined by the piston to a low-pressure site such as a drain site to reduce an internal pressure thereof. Thus, the balance piston valve is opened and closed by selectively providing a communication between said one of the chambers and the low-pressure site. For this purpose, a solenoid of small capacity may be used so that the valve can be downsized and lightened.

The aforementioned poppet valve is adapted to open and close the oil passage but is not adapted to regulate hydraulic pressure. For this reason, according to the teachings of the foregoing prior art documents, a feedback-control of a solenoid current of the valve is carried out based on a pressure difference (control deviation) between an actual pressure of the chamber of the pulley detected by a sensor and a target pressure thereof. However, as described, the poppet valve cannot regulate the hydraulic pressure. Therefore, the current applied to the solenoid may not be controlled accurately by merely controlling the current based on the control deviation.

Consequently, an inflection point is created on an increasing curve of an oil flow with respect to a current depending on a structure of the aforementioned balance piston valve. That is, in order to control the flow rate of the oil with respect to the current by the balance piston valve, different gains are required depending on a magnitude of control deviation. In addition, different control gains of the flow rate are also required in an upstream and downstream of the valve. Consequently, a flow rate and pressure of the oil with respect to a predetermined current may not be controlled accurately and varied depending on a situation. In order to avoid such disadvantages, the control gain may be corrected in accordance with the situation such as a pressure difference between the upstream side and the downstream side of the valve. However, since the control gain is affected by various factors indeed, enormous data and works are required to prepare a map for correcting the control gain.

In case of using a solenoid valve taught by Japanese Patent Laid-Open No. 2011-52796 whose increasing curve of an oil flow has no particular inflection point, a flow rate of the oil with respect to the given current or opening degree is also different in the upstream side and the downstream side of the valve. Therefore, the hydraulic pressure may not be controlled stably. In addition, in the valve taught by Japanese Patent Laid-Opens Nos. 2011-163508 and 2011-52796 which is closed by pushing the valve element onto the valve seat and opened by detaching the valve element from the valve seat, a distance of the valve element withdrawn from the valve seat is increased according to an increment of the current applied thereto so that an opening area for letting through the oil is increased. That is, since the opening area of the valve is thus varied in accordance with the applied current, the flow rate of the oil with respect to the given current may not be controlled stably. The above-mentioned technical problem may occur not only in a hydraulic control system for automatic transmission of automobiles but also in a hydraulic control system for other industrial machineries.

A speed ratio of a continuously variable transmission described in the foregoing prior art documents is controlled to operate the engine in an optimally fuel efficient manner. To this end, specifically, the speed ratio of the continuously variable transmission is controlled in a manner such that an actual engine speed is adjusted to a target engine speed determined based on a vehicle speed and an opening degree of accelerator. Such adjustment of the speed ratio is carried out on a constant basis and the speed ratio of the continuously variable transmission will not be changed significantly by the adjustment. In contrast, when the speed ratio is required to be changed significantly by depressing an accelerator pedal deeply or returning the accelerator pedal while depressing a brake pedal, the oil is delivered to one of the pulleys and discharged from the other pulley. That is, when the speed ratio is required to be changed significantly, larger amount of the oil is delivered and discharged to/from the pulleys. Thus, required amounts of the oil are different in those cases. Therefore, if the flow rate of the oil is controlled by the feedback method in both cases based on the control deviation between the actual oil pressure detected by the hydraulic sensor and the target pressure, the flow rate of the oil may not be controlled accurately and a speed change operation of the transmission may be delayed.

### SUMMARY OF INVENTION

The present invention has been conceived noting the foregoing technical problems, and it is therefore an object of the present invention is to improve controllability of a hydraulic control system having a valve that is opened and closed to control a flow rate of oil in accordance with a current applied thereto.

The present invention is applied to a hydraulic control system comprising a feeding passage that delivers fluid to a control object; a draining passage that drains the fluid from the control object; and a control valve that is disposed on at least one of the feeding passage and the draining passage, and that is adapted to deliver or drain the fluid to/from the control object in accordance with an applied current calculated based on a difference between a target pressure and an actual pressure of the control object. In order to achieve the above-mentioned objective, according to the present invention, the hydraulic control system is configured to: calculate a desired fluid volume to adjust the actual pressure to the target pressure based on said difference; and calculate a current value to achieve the desired fluid volume based on a relation between a current value applied to the control valve and an outflow rate of the control valve.

The control valve includes a valve adapted to open the passage upon application of the current thereto. A flow rate of the fluid flowing through the valve is varied depending on a pressure difference between an upstream side and a downstream side. In addition, the relation between the current value applied to the control valve and the outflow rate of the control valve is changed depending on said pressure difference.

The control valve includes a balance piston type poppet valve comprising: a piston having a valve element on one of end portions; a cylinder holding the piston while allowing to reciprocate therein; an inlet port formed in a first chamber of the cylinder holding the valve element; an outlet port opened and closed by the valve element; a diametrically reduced connection passage that provides a communication between the first chamber holding the valve element and a second chamber of an opposite side to the first chamber; and an electromagnetic valve that is activated by applying a current thereto to selectively connect the second chamber to a passage connected to the outlet port.

The control object includes a hydraulic chamber of a belt-driven continuously variable transmission adapted to change a width of a groove thereof holding a drive belt.

The hydraulic control system is further configured to correct a desired fluid volume to adjust the actual pressure to the target pressure by a fluid volume required to change the groove width to achieve a target speed ratio, or by a deficiency of a fluid volume caused by an oil leakage.

The belt-driven continuously variable transmission includes a first pulley adapted to change the groove width to change the speed ratio and a second pulley adapted to establish a belt clamping pressure, and the control object includes the hydraulic chamber of the second pulley. In addition, the hydraulic control system is further configured to correct the fluid volume in the hydraulic chamber of the second pulley by a change in a capacity of the hydraulic chamber of the first pulley to achieve the target speed ratio.

The control valve may be individually disposed on each of the feeding passage connected to the hydraulic chamber and the draining passage.

Instead, the control valve may be disposed only on the feeding passage connected to the hydraulic chamber.

Alternatively, the control valve may also be disposed only on the draining passage connected to the hydraulic chamber.

Thus, according to the present invention, the current applied to the control valve is controlled based on the pressure difference. To this end, the desired fluid volume is determined based on the pressure difference while taking account of hydraulic stiffness in the control object and auxiliaries. Then, the desired fluid volume thus determined is converted into a current value for controlling the control valve while taking account of a relation between the applied current to the valve and a flow rate of the fluid flowing therethrough. That is, according to the present invention, the hydraulic control system is configured not to obtain the desired fluid based on the current value, but to obtain the current value based on the desired fluid volume. Accordingly, the desired fluid volume can be achieved accurately by activating the control valve by the current value thus obtained irrespective of an outflow condition of the valve in response to the applied current. In other words, the actual pressure is allowed to accurately track the target pressure without deviating significantly and without causing delay so that faster convergence is achieved.

Control accuracy can be improved by calculating the current value applied to the control valve while taking account of the relation between the applied current and the outflow of the valve which is varied depending on the pressure difference between the upstream side and the downstream side of the valve.

It is to be noted that the increasing curve of the outflow of the balance piston type poppet valve with respect to the applied current may have some inflection points. According to the present invention, however, the outflow of the poppet valve used as the control valve can be controlled accurately by thus applying the current corresponding to the desired flow volume.

In the belt-driven continuously variable transmission, specifically, a leakage of the fluid from the pulley and a drainage of the fluid to the drain site can be prevented so that energy efficiency can be improved.

In addition, the current value applied to the control valve is corrected by the correction value to compensate deficiency and excess of the hydraulic pressure resulting from a speed change operation of the transmission or a leakage of the fluid. Therefore the electric current applied to the control valve can be controlled easily and accurately.

Further, deficiency and excess of the hydraulic pressure resulting from a speed change operation of the transmission can be calculated based on a change in a capacity of the hydraulic chamber of the first pulley to ensure a belt clamping pressure of the second pulley. Therefore the hydraulic pressure during a speed change operation can be controlled easily and accurately.

### BRIEF DESCRIPTION OF THE DRAWINGS

FIG. 1 is a flowchart showing a control example of the hydraulic control system according to the present invention.

FIG. 2 is a block diagram showing an example for controlling a belt clamping pressure of the continuously variable transmission.

FIG. 3 is a graph schematically showing a relation among a current applied to a control valve, a flow rate, and a pressure difference.

FIG. 4 is a graph showing an example of a flow rate curve of the valve having inflection points.

FIG. 5 is a hydraulic diagram schematically showing one example of the hydraulic control system for a belt-driven continuously variable transmission according to the present invention.

FIG. 6 is a cross-section view schematically showing a balance piston type control valve.

FIG. 7 is a hydraulic diagram showing another example of the hydraulic control system in which the balance piston valve is arranged in a high pressure site.

### DESCRIPTION OF THE PREFERRED EMBODIMENT(S)

The hydraulic control system of the present invention is configured to control hydraulic pressure of an actuator of automobiles and other industrial machineries by delivering and draining fluid to/from the actuator. To this end, a control valve adapted to control a flow rate of the fluid in accordance with an applied current is used to control an amount of the fluid delivered and discharged to/from the actuator. The control valve used in the hydraulic control system is not provided with a feedback port to regulate hydraulic pressure. That is, according to the preferred example, the control valve is adapted to control the pressure of a control object such as the actuator by controlling a flow rate of the fluid.

Referring now to FIG. 5, there is shown a preferred example of a hydraulic control system for controlling a hydraulic chamber of a pulley of a belt-driven continuously variable transmission. The belt-driven continuously variable transmission 1 is comprised of a drive pulley 3, a driven pulley 4, and a belt 2 running between those pulleys. Specifically, each pulley 3 and 4 is individually comprised of a fixed sheave and a movable sheave allowed to move with respect to the fixed sheave. A width of a groove formed between those pulleys can be altered by moving the movable sheave relatively with respect to the fixed sheave so that a speed ratio of the transmission 1 can be changed continuously. In order to actuate the movable sheave, each pulley 3, 4 is individually provided with a hydraulic chamber 5, 6. The drive pulley 3 is rotated by a torque delivered from an engine 7, and a torque of the driven pulley 4 is delivered to rotate not shown drive wheels. A speed ratio the transmission 1 can be varied by changing the groove width of one of the pulleys 3 and 4 to alter a running radius of the belt 2 while adjusting a belt clamping pressure of the other pulley in a manner to achieve a desired torque transmitting capacity. According to the example shown in FIG. 5, the drive pulley is adapted to change the speed ratio, and the driven pulley 4 is adapted to establish the belt clamping pressure.

A hydraulic circuit shown in FIG. 5 is adapted to deliver fluid to the hydraulic chamber 6 of the driven pulley 4 and to discharge the fluid from the hydraulic chamber 6. An oil pump 8 is driven by the engine 7 or a not shown motor, and connected to an accumulator 11 through a line pressure passage 10. In order to regulate a pressure of the fluid discharged from the oil pump 8 to a line pressure according to an engine load etc., a regulator valve 9 is disposed on the line pressure passage 10. A hydraulic sensor 12 is connected to the accumulator 11 to detect an internal pressure of the accumulator 11, and a check valve 13 is disposed between the accumulator 11 and the regulator valve 9 to prevent the fluid from flowing backwardly to the regulator valve 9.

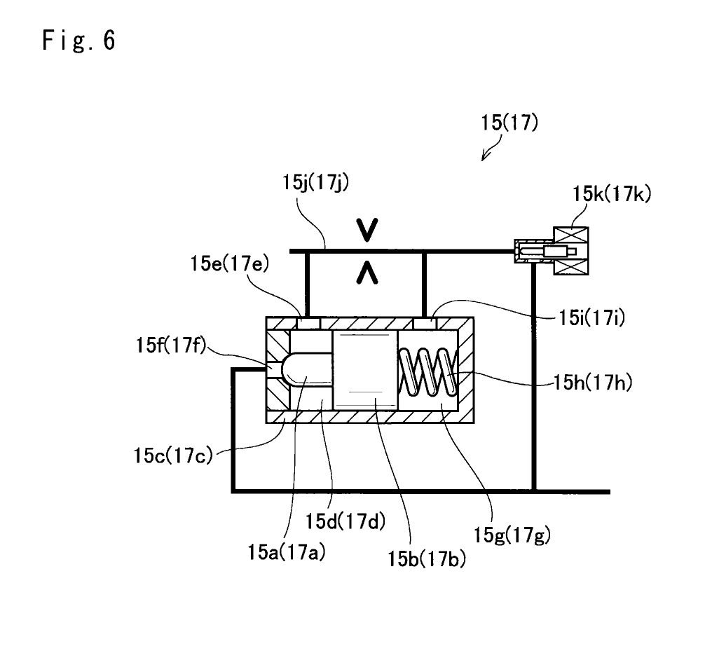

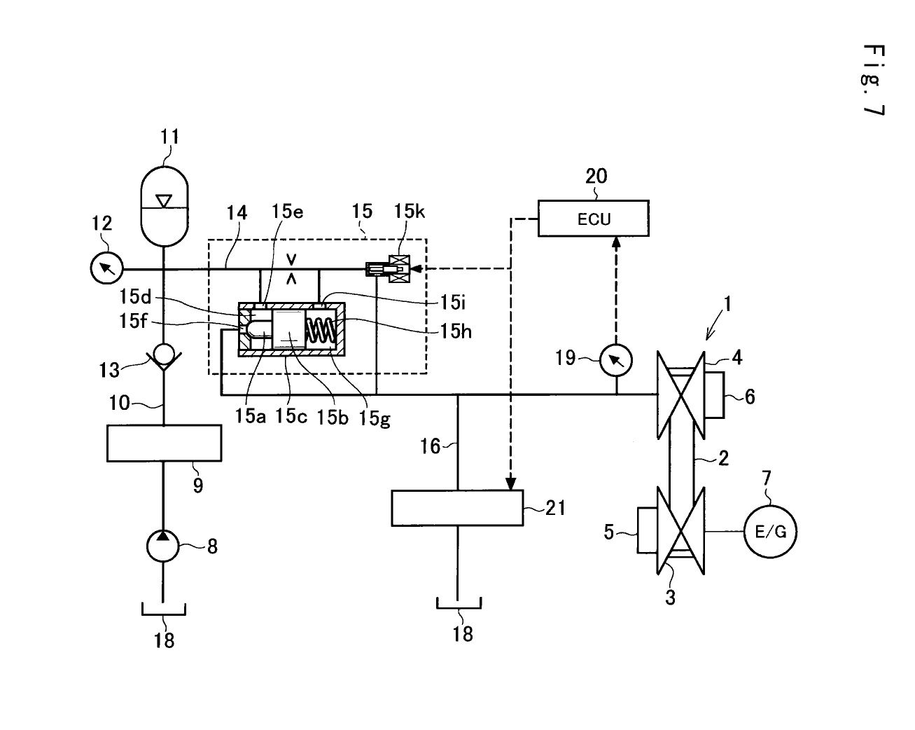

A feed control valve 15 is disposed on a feeding passage 14 for delivering the fluid to the hydraulic chamber 6 of the driven pulley 4 from the line pressure passage 10 or the accumulator 11, and a drain control valve 17 is disposed on a draining passage 16 for draining the fluid from the hydraulic chamber 6 to a drain site such as an oil pan. A balance piston type poppet valve is used to serve as the control valve 15 and 17 respectively, and hence structures of those valves are similar to each other. Referring now to FIG. 6, there is shown a structure of the control valve 15 (or 17) in an enlarged scale. As shown in FIG. 6, a piston 15b (17b) integrated with a valve element 15a (17a) is held in a cylinder 15c (17c) while being allowed to reciprocate therein. An inlet port 15e (17e) to which relatively highly pressurized fluid is introduced, and an outlet port 15f (17f) from which the fluid is drained to a low pressure site are formed in a chamber 15d (17d) of the cylinder 15c (17c) holding the valve element 15a (17a). Specifically, the outlet port 15f (17f) is formed on an end plate of the cylinder 15c (17c) to be closed by pushing a leading end of the valve element 15a (17a) thereto, and to be opened by withdrawing the valve element 15a (17a) therefrom. For this purpose, a spring 15h (17h) for pushing the valve element 15a (17a) toward the outlet port 15f (17f) is arranged in a chamber 15g (17g) formed on the other side of the chamber 15d (17d) across the piston 15b (17b), and a signal pressure port 15i (17i) is formed in the chamber 15g (17g). Additionally, a diametrically reduced connection passage 15j (17j) is arranged to provide a communication between the signal pressure port 15i (17i) and the inlet port 15e (17e) while choking the fluid flowing therethrough. Alternatively, the connection passage 15j (17j) may also be formed by axially penetrating the piston 15b (17b) to provide a communication between the chambers 15d (17d) and 15g (17g). In addition, the signal pressure port 15i (17i) is connected to an electromagnetic valve 15k (17k) that is opened in response to a current applied thereto so that the signal pressure port 15i (17i) is connected to the inlet port 15e (17e) by opening the electromagnetic valve 15k (17k). That is, the electromagnetic valve 15k (17k) is adapted to connect the chamber 15g (17g) holding the spring 15h (17h) selectively to the low-pressure site. Thus, each control valve 15 and 17 is individually adapted to increase the flow rate in accordance with a current value applied to each electromagnetic valve 15k and 17k.

Specifically, in the feed control valve 15, the inlet port 15e is connected to the feeding passage 14, and the outlet port 15f is connected to the hydraulic chamber 6 of the driven pulley 4. On the other hand, in the drain control valve 17, the inlet port 17e is connected to the hydraulic chamber 6 of the driven pulley 4, and the outlet port 17f is connected to the drain site such as an oil pan 18. In addition, a hydraulic sensor 19 is arranged to detect a pressure in the hydraulic chamber 6, and the detected pressure is transmitted in the form of signal.

According to the preferred example, the hydraulic control system is provided with an electronic control unit (abbreviated as the “ECU” hereinafter) 20 serving as a controller for controlling the belt-driven continuously variable transmission 1. The ECU 20 is comprised of a microcomputer configured to carry out a calculation based on incident data including a vehicle speed, an opening degree of the accelerator, and detection signal of the hydraulic sensor 12 and 19 and preinstalled data, and to transmit a calculation result in the form of command signal. Especially, the ECU 20 is configured to control a current applied to each control valve 15 and 17 (i.e., to the electromagnetic valve 15k and 17k) based on the hydraulic pressure detected by each hydraulic sensor 12 and 19.

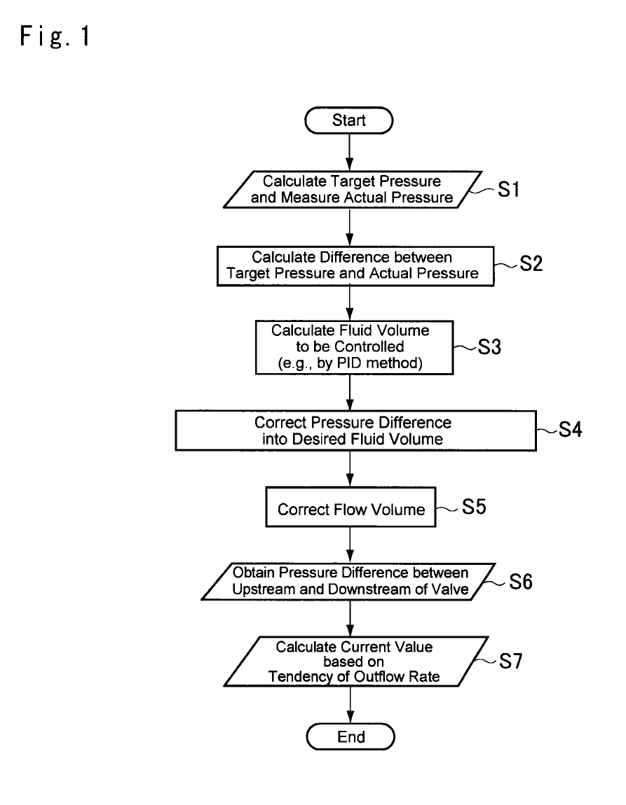

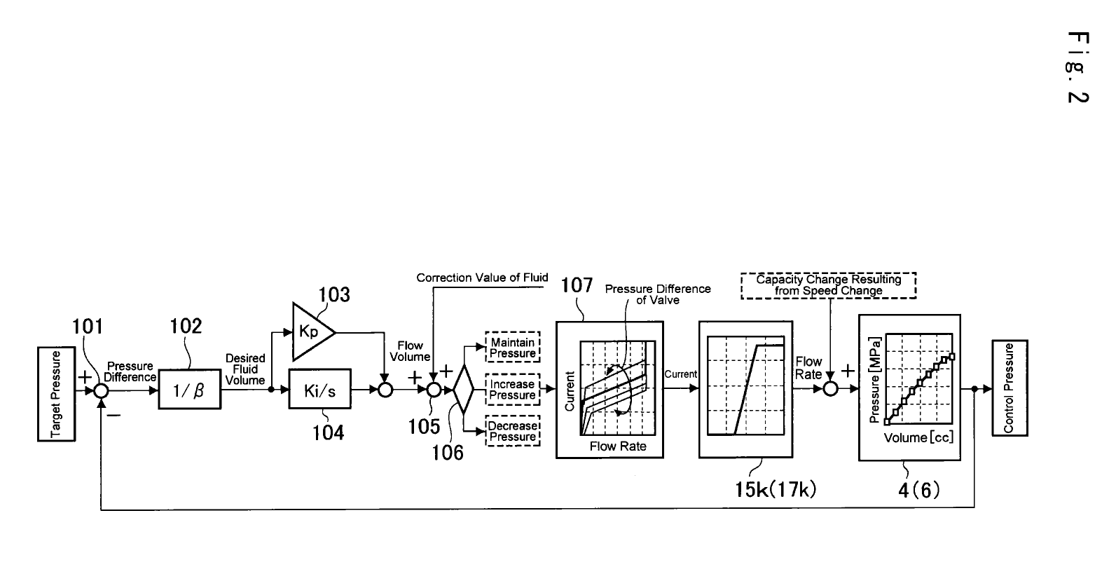

The hydraulic control system of the preferred example performs the following controls in the above described hydraulic circuit. FIG. 1 is a flowchart for explaining the control example, and FIG. 2 is a block diagram for explaining the control logic. In order to control a belt clamping pressure of the belt-driven continuously variable transmission 1, first of all, a target pressure is calculated and an actual pressure is measured (at step S1). Specifically, a target belt clamping pressure of the belt-driven continuously variable transmission 1 is calculated by a conventional method based on a drive demand estimated from an opening degree of the accelerator, and a vehicle speed. On the other hand, the actual pressure of the hydraulic chamber 6 of the driven pulley 4 is measured by the hydraulic sensor 19. Then, a difference between the target pressure and the actual pressure is calculated (at step S2), and such calculation at step S2 is indicated as a subtractor 101 in the block diagram shown in FIG. 2.

Then, a fluid volume to be controlled as an output of a feedback control such as a Proportional-Integral-Derivative control is calculated based on the difference between the target pressure and the actual pressure using a control gain determined taking account of response and stability of the control (at step S3). Further, a desired fluid volume is calculated based on the difference between the target pressure and the actual pressure (at step S4). Here, the calculation of step S3 may be carried out not only after step S3 but also be carried out before step S3 and simultaneously with step S3. Specifically, the difference between the target pressure and the actual pressure is converted into the desired fluid volume while taking account of hydraulic stiffness. The hydraulic stiffness can be expressed by a ratio of a change in a hydraulic pressure to a change in a fluid volume. For instance, if the hydraulic stiffness is low, hydraulic pressure in the control object will not be increased significantly even if the fluid is delivered thereto. By contrast, if the hydraulic stiffness is high, hydraulic pressure in the control object can be increased by a small amount of the fluid delivered thereto. To this end, the hydraulic stiffness of the hydraulic circuit and the control object may be obtained based on experiments, simulations or measurements using the actual devices. Here, the difference between the target pressure and the actual pressure can be converted into the desired fluid volume with reference to a preinstalled map or using a predetermined formula.

Thus, according to the example shown in FIG. 1, the current fluid volume to be controlled is calculated continuously (or at each cycle of the routine in FIG. 1) based on the difference between the target pressure and the actual pressure, and then the difference between the target pressure and the actual pressure is converted into the desired fluid volume while taking account of the hydraulic stiffness. Such order of the control may be inverted as shown in FIG. 2. Specifically, it is also possible to convert the difference between the target pressure and the actual pressure into the desired fluid volume by a converter 102 while taking account of the hydraulic stiffness β, and then calculate the current fluid volume to be controlled continuously (or at each cycle of the routine in FIG. 1) based on the desired fluid volume by a proportionator 103 and an integrator 104.

Then, a correction value is added to the flow volume thus obtained (at step S5). Such calculation of step S5 is indicated as an “adder” 105 in the block diagram shown in FIG. 2. Specifically, the correction value is added to the desired fluid volume to achieve or maintain the hydraulic pressure to clamp the belt in accordance with a drive demand. For example, the correction value of the fluid volume is determined based on other factors such as surplus or deficiency of the fluid volume to clamp the belt resulting from changing a capacity of the hydraulic chamber 6 to change the speed ratio, or deficiency of the fluid volume to clamp the belt due to failure detected by the hydraulic sensor 19. If the speed change operation is not being carried out, or if a failure is not currently detected, the correction value will be “0” and hence the step S5 is skipped without carrying out any specific control. To the contrary, if the capacity of the hydraulic chamber 6 is increased by a downshifting or if an oil leakage is caused due to failure, a correction value is added to the desired fluid volume at step S5. By contrast, if the capacity of the hydraulic chamber 6 is decreased by an upshifting, a correction value is subtracted from (or a negative amount is added to) the desired fluid volume at step S5.

The correction value of the fluid may be calculated by following method. For example, the correction value for the case of speed change operation may be calculated based on a structure of the pulleys 3 and 4 of the belt-driven continuously variable transmission 1. Specifically, in the transmission 1, a running radius of the drive belt 2 in each pulley 3 and 4 is determined based on a target speed ratio to achieve a target speed of the engine 7, and a position of the movable sheave of each pulley 3 and 4 to achieve the groove width to hold the drive belt 2 at the desired running radius is determined structurally. A change in capacity of each chamber 4 and 6 can be obtained based on positions of the movable sheave to achieve a target speed ratio and a current speed ratio, and correction value of the fluid can be calculated based on the change in capacity of each chamber 4 and 6 thus obtained. In turn, the correction value for the case of an oil leakage may be calculated based on the hydraulic stiffness obtained in advance and a leakage amount obtained from a reduction in the pressure measured by the hydraulic sensor 19.

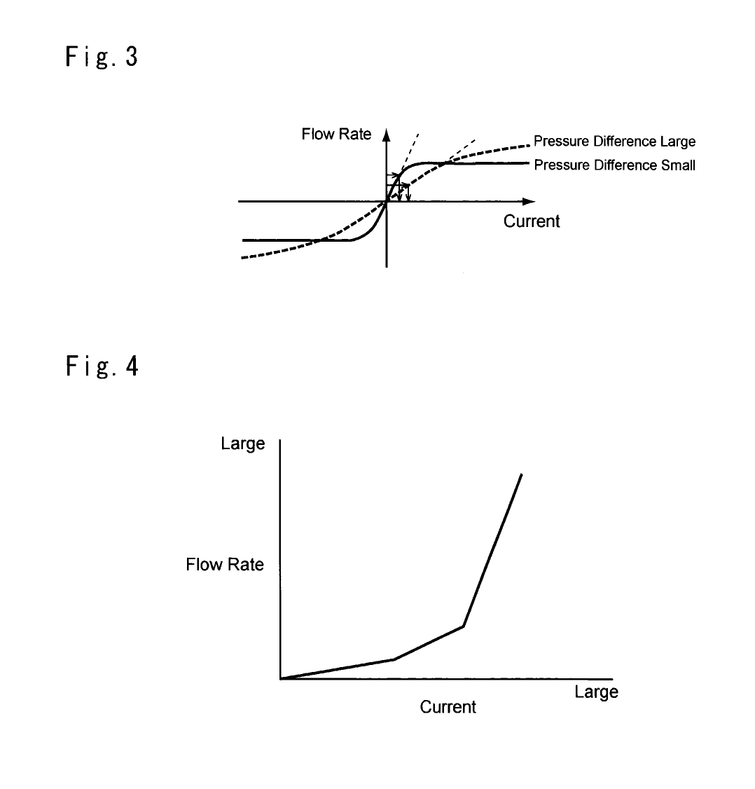

Further, a pressure difference between the upstream side and the downstream side of each control valve 15 and 17 is obtained (at step S6). A flow rate of the fluid flowing through the poppet valve that does not have a feedback port varies depending not only on an opening degree of the valve but also on a pressure difference between the upstream side and the downstream side of the valve. Such change in an outflow rate of the poppet valve is shown in FIG. 3. As to the normal-close valve shown in FIG. 3, an outflow rate of the fluid flowing therethrough is increased in proportion to a current applied thereto. However, if the pressure difference between the upstream side and the downstream side of the control valve is large, the outflow rate of the fluid flowing therethrough is increased gently, but if such pressure difference is small, the outflow rate is increased sharply to an upper limit even by a low current. Thus, a tendency of the outflow rate of the poppet valve varies depending on the pressure difference between the upstream side and the downstream side. Therefore, in order to recognize the present tendency of the outflow rate, the pressure difference between the upstream side and the downstream side of the feed control valve 15 is measured by the hydraulic sensors 12 and 19, and the pressure difference between the upstream side and the downstream side of the drain control valve 17 corresponding to a pressure in the hydraulic chamber 6 of the driven pulley 4 is measured by the hydraulic sensor 19. Here, the measurement of step S6 may be carried out not only after step S5 but also be carried out before step S5 and simultaneously with step S5. Then, a current value to achieve the desired fluid volume is calculated based on the tendency of the outflow rate of the control valve thus obtained based on the pressure difference between the upstream side and the downstream side (at step S7).

Referring back to the block diagram shown in FIG. 2, after the correction value is added to the desired fluid volume, a selector 106 determines to maintain, to increase or to decrease the hydraulic pressure based on the desired fluid volume corrected by the correction value. If the desired fluid volume is “0”, the control valve 15 and 17 are maintained to be closed. In turn, if the hydraulic pressure has to be increased, the current value applied to the feed control valve 15 is calculated by a current calculator 107 based on the above-explained tendency of the outflow rate of the valve. By contrast, if the hydraulic pressure has to be decreased, the current value applied to the drain control valve 17 is calculated by the current calculator 107 based on the above-explained tendency of outflow rate of the valve. Then, the current value thus calculated is transmitted to the electromagnetic valve 15k (17k) in the form of a command signal thereby allowing the fluid to flow through the control valve 15 (17) in the commanded amount. That is, the fluid is allowed to flow through the control valve 15 (17) in the desired fluid volume used to calculate the current value. In this situation, if the desired fluid volume has been corrected by the correction value relating to a change in the capacity of the chamber 4 or 6 during a speed change operation, the fluid is allowed to flow through the control valve 15 (17) in the desired fluid volume corrected by the correction value. Consequently, the pressure of the hydraulic chamber 5 or 6 of the pulley 3 or 4 is adjusted in accordance with the desired fluid volume. As described, the desired fluid volume is calculated taking account of the hydraulic stiffness so that the actual pressure of the pulley can be adjusted to achieve the target pressure.

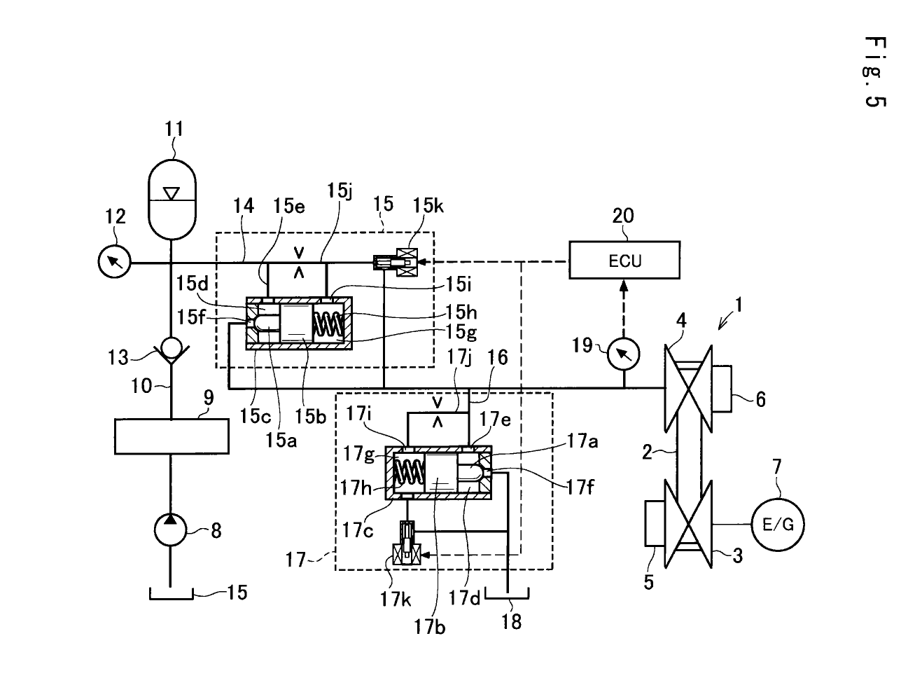

Thus, according to the preferred example, the desired fluid volume applied to the control object is calculated based on the difference between the target pressure and the actual pressure while taking account of the hydraulic stiffness, and the current value for controlling the valve is calculated based on the desired fluid volume thus calculated. Therefore, even if the valve is in condition where the flow rate of the fluid flowing therethrough is changed significantly in response to a change in the current applied thereto, the hydraulic pressure applied to the control object can be controlled stably without changing the control gain. As described, the balance piston type control valve is opened by energizing the electromagnetic valve connected thereto. Consequently, the fluid is allowed to flow from the high pressure side to the low pressure side through the electromagnetic valve so that the piston is moved to open the control valve. In this situation, a flow rate of the fluid flowing through the control valve is increased by increasing an opening degree of the control valve. A relation between the outflow rate of the valve thus structured and the current applied thereto is shown in FIG. 4, and as can be seen from FIG. 4, an increasing curve of the outflow rate has some inflection points. Given that the control current applied to the valve is calculated based on the difference between the target pressure and the actual pressure, the control gain has to be altered significantly depending on values of the outflow rate and the current to control the valve. In this case, specifically, different gains are required for the case in which the outflow rate and the current are small and for the case in which the outflow rate and the current are large, and this makes it difficult to control the hydraulic pressure accurately and stably. However, according to the preferred example, the control system is configured to calculate the current value applied the valve based on the desired fluid volume so that it is unnecessary to alter the control gain frequently irrespective of the values of the outflow rate and the current. Thus, according to the preferred example, the hydraulic pressure applied to the control object can be controlled accurately and stably.

The present invention may also be applied to the hydraulic control system for other industrial machineries to prevent oil leakage and to improve energy efficiency, as well as the hydraulic control system for the belt-driven continuously variable transmission. Additionally, it is not necessary to use the balance piston type control valves for both drain control valve and feed control valve of the hydraulic control system for the belt-driven continuously variable transmission. For example, in the modified example of the hydraulic control system shown in FIG. 7, the balance piston valve is used as the feed control valve 15, and a conventional regulator valve such as a spool type liner solenoid valve is used as the drain control valve 21. According to the modified example, the fluid in the line pressure passage 10 can be confined without leakage even when the engine 7 and the oil pump 8 are stopped so that the line pressure can be maintained. Given that an engine stopping control is applied to the vehicle, the vehicle is additionally provided with an electronic oil pump to ensure the hydraulic pressure or to deliver the fluid to the accumulator 11 while stopping the engine 7. In this case, since the line pressure can be maintained even when the engine 7 is stopped, the smaller electronic oil pump and the accumulator 11 may be used so that the vehicle or the transmission can be downsized and lightened.

Instead of the structure shown in FIG. 7, it is also possible to use the balance piston type control valve as the drain control valve, and to use the regulator valve as the feed control valve. In this case, drainage of the fluid from the control object such as the hydraulic chamber 4 or 6 can be reduced so that a load on the oil pump 8 and a power loss thereof can be reduced. As described, the pressure difference between the upstream side and the downstream side of the balance piston valve has to be measured to carry out the control of the invention. For this purpose, the hydraulic control systems shown in FIG. 5 or 7 are individually provided with the hydraulic sensor for detecting hydraulic pressure applied to the pulley. Such hydraulic sensor may serve as an inflow sensor so that number of the hydraulic sensors can be reduced and hence the hydraulic system can be simplified and downsized.

In addition, a valve that is opened and closed by actuating a valve element directly by a solenoid may also be used in the hydraulic control system as the control valve. In this case, the current value applied to the valve may also be calculated based on the difference between the target pressure and the actual pressure. For this reason, the hydraulic pressure applied to the control object can be controlled stably without changing the control gain frequently.

### REFERENCE SIGNS LIST

1: belt-driven continuously variable transmission; 3: drive pulley; 4: driven pulley; 5, 6: hydraulic chamber; 7: engine; 12: hydraulic sensor; 14: feeding passage; 15, 17: control valve; 16: draining passage; 15a, 17a: valve element; 15b, 17b: piston; 15c, 17c: cylinder; 15d, 17d: chamber; 15e, 17e: inlet port; 15f, 17f: outlet port; 15g, 17g: chamber; 15h, 17h: spring; 15i, 17i: signal pressure port; 15j, 17j: connection passage; 15k, 17k: electromagnetic valve; 19: hydraulic sensor; 20: electronic control unit (ECU); 101: subtractor; 102: converter; 103: proportionator; 104: integrator; 105: adder; 106: selector; 107: current calculator.

1. A hydraulic control system, comprising:
a feeding passage that delivers fluid to a control object;
a draining passage that drains the fluid from the control object; and
a control valve that is disposed on at least one of the feeding passage and the draining passage, and that is adapted to deliver or drain the fluid to/from the control object in accordance with an applied current calculated based on a difference between a target pressure and an actual pressure of the control object,
wherein the hydraulic control system is configured to:
calculate a desired fluid volume to adjust the actual pressure to the target pressure based on said difference; and
calculate a current value to achieve the desired fluid volume based on a relation between a current value applied to the control valve and an outflow rate of the control valve.

2. The hydraulic control system as claimed in claim 1,
wherein the control valve includes a valve adapted to open the passage upon application of the current thereto, in which the outflow rate thereof is varied depending on a pressure difference between an upstream side and a downstream side; and
wherein the relation between the current value applied to the control valve and the outflow rate of the control valve includes a relation therebetween that is changed depending on said pressure difference.

3. The hydraulic control system as claimed in claim 1, wherein the control valve includes a balance piston type poppet valve comprising:
a piston having a valve element on one of end portions;
a cylinder holding the piston while allowing to reciprocate therein;
an inlet port formed in a first chamber of the cylinder holding the valve element;
an outlet port opened and closed by the valve element;
a diametrically reduced connection passage that provides a communication between the first chamber holding the valve element and a second chamber of an opposite side to the first chamber; and
an electromagnetic valve that is activated by applying a current thereto to selectively connect the second chamber to a passage connected to the outlet port.

4. The hydraulic control system as claimed in claim 1, wherein the control object includes a hydraulic chamber of a belt-driven continuously variable transmission adapted to change a width of a groove thereof holding a drive belt.

5. The hydraulic control system as claimed in claim 4, wherein the hydraulic control system is further configured to correct a desired fluid volume to adjust the actual pressure to the target pressure by a fluid volume required to change the groove width to achieve a target speed ratio, or by a deficiency of a fluid volume caused by an oil leakage.

6. The hydraulic control system as claimed in claim 4,
wherein the belt-driven continuously variable transmission includes a first pulley adapted to change the groove width to change the speed ratio, and a second pulley adapted to establish a belt clamping pressure,
wherein the control object includes the hydraulic chamber of the second pulley, and
wherein the hydraulic control system is further configured to correct the fluid volume in the hydraulic chamber of the second pulley by a change in a capacity of the hydraulic chamber of the first pulley to achieve the target speed ratio.

7. The hydraulic control system as claimed in claim 4, wherein the control valve is individually disposed on each of the feeding passage connected to the hydraulic chamber and the draining passage.

8. The hydraulic control system as claimed in claim 4, wherein the control valve is disposed only on the feeding passage connected to the hydraulic chamber.

9. The hydraulic control system as claimed in claim 4, wherein the control valve is disposed only on the draining passage connected to the hydraulic chamber.
